(19) United States
(12) Patent Application Publication
(10) Pub. No.: US 2019/0238515 A1
(43) Pub. Date: Aug. 1, 2019

(54) SYSTEM AND METHODS FOR ANONYMOUS IDENTIFICATION AND INTERACTION BETWEEN ELECTRONIC DEVICES

(71) Applicant: BiFrost LLC, Gaithersburg, MD (US)

(72) Inventors: Edward W. Dodd, Gaithersburg, MD (US); Edward Wyrwas, Severn, MD (US)

(73) Assignee: BiFrost LLC, Gaithersburg, MD (US)

(21) Appl. No.: 15/663,873

(22) Filed: Jul. 31, 2017

Related U.S. Application Data
(60) Provisional application No. 62/372,008, filed on Aug. 8, 2016.

(51) Int. Cl. H04L 29/06; G06F 16/22

(52) U.S. Cl. CPC H04L 63/0421; G06Q 30/0239; G06F 16/22

(57) ABSTRACT

A system and methods for anonymous identification and interaction between electronic devices is provided. A method for anonymous identification and interaction between electronic devices may include the steps of: receiving an event creation request from a first user, via a first client device, the event creation request comprising event data and a request to interact with a second client device of a second user proximate to the first user; recording identifying information, via the first client device, from the second client device proximate to the first user; storing the event data and the recorded identifying information of the second client device in a database, the database accessible to a server; determining if the device identifying information of the second client device matches a client device associated with a user in the database; and providing the event data to the second client device when a data record is created in the database, the data record associating the second user with the device identifying information of the second client device.

### CROSS REFERENCE TO RELATED APPLICATIONS

This application claims priority to and the benefit of the filing date of U.S. Provisional Application No. 62/372,008, filed on Aug. 8, 2016, entitled “SYSTEMS AND METHODS FOR ANONYMOUS IDENTIFICATION AND INTERACTION BETWEEN ELECTRONIC DEVICES”, which is hereby incorporated by reference in its entirety.

### FIELD OF THE INVENTION

This patent specification relates to the field of providing interaction between electronic devices. More specifically, this patent specification relates to systems and methods that are configured to anonymously identify and enable interaction between electronic devices.

### BACKGROUND

Current electronic device communication methods require the initiator to have prior knowledge of the email address, text number, user profile for individual(s), or other contact information with whom they would like to interact. While this works well for communication with a known contact, it is impossible to use these means to communicate with strangers and electronic devices with unknown contact information in the immediate vicinity. This prevents users from interacting with individuals over short distances without the exchange of any account information and prevents strangers from interacting while respecting and maintaining privacy.

Therefore, a need exists for novel systems and methods for providing interaction between electronic devices. A further need exists for novel systems and methods that are able to provide anonymous identification and interaction between electronic devices Finally, a need exists for novel systems and methods which allow users to interact with individuals over short distances without the exchange of any account information thereby allowing strangers to interact while respecting and maintaining privacy.

### BRIEF SUMMARY OF THE INVENTION

A system and methods for anonymous identification and interaction between electronic devices is provided. The system and methods may be used by the system to perform anonymous identification of and interaction and between one or more electronic devices that were or are in proximity to each other at a point in time, such as by being at the same event. Additionally, the system and methods may be used to record people or client devices at an event, to provide data to a client device that was at the event at a later time, to allow users to interact with individuals over short distances without exchange of any account information, and the like.

In some embodiments, the system may include: a first client device having a display screen and an input interface for receiving input from a first user; a second client device having a display screen and an input interface for receiving input from a second user; and a computing platform having a processor, a memory in communication with the processor. Event creation logic may be stored in the memory, executable by the processor and configured to receive an event creation request from a first user, via the first client device, the event creation request comprising event data and a request to interact with a second client device of a second user proximate to the first user. Detection logic may be stored in the memory, executable by the processor and configured to record identifying information, via the first client device, from the second client device proximate to the first user. Recording logic may be stored in the memory, executable by the processor and configured to store the event data and the recorded identifying information of the second client device in a database, the database accessible to a server. Matching logic may be stored in the memory, executable by the processor and configured to determine if the device identifying information of the second client device matches a client device associated with a user in the database. Notification logic may be stored in the memory, executable by the processor and configured to provide the event data to the second client device when a data record is created in the database, the data record associating the second user with the device identifying information of the second client device.

In some embodiments, a method for anonymous identification and interaction between electronic devices may include the steps of: receiving an event creation request from a first user, via a first client device, the event creation request comprising event data and a request to interact with a second client device of a second user proximate to the first user; recording identifying information, via the first client device, from the second client device proximate to the first user; storing the event data and the recorded identifying information of the second client device in a database, the database accessible to a server; determining if the device identifying information of the second client device matches a client device associated with a user in the database; and providing the event data to the second client device when a data record is created in the database, the data record associating the second user with the device identifying information of the second client device.

In further embodiments, a method for anonymous identification and interaction between electronic devices may include the steps of: polling for one or more client devices which are in range or proximate to a first client device; cataloging the unique identifiers of any second client devices which are proximate or in range to a first client device; compiling a list of the unique identifiers of the second client devices; transmitting a list of the identifiers along with an event log to a server or central computer; determining if a record of each of the identifiers in the list of identifiers along with event log is pre-existing in a database of the system; logging the event to an existing data record in the database; determining if an identifier record links to or is associated with a user account; and notifying the owner of the account of participation in the event.

In still further embodiments, a method for anonymous identification and interaction between electronic devices may include the steps of: collecting identifying information from proximate devices; transmitting event data describing an event and proximate devices; determining if device identifying information matches a client device associated with a user; creating a data record for an unmatched client device which is not associated with a user; and associating event data of unmatched client device with user.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an illustrative example of some of the components and computer implemented methods which may be found in a system for anonymous identification and interaction between electronic devices according to various embodiments described herein.

FIG. 2 illustrates an example of a first user interacting with other users proximate to the first user at an event according to various embodiments described herein.

FIG. 3 shows a block diagram showing an example of a server which may be used by the system as described in various embodiments herein.

FIG. 4 depicts a block diagram illustrating an example of a client device which may be used by the system as described in various embodiments herein.

FIG. 5 a block diagram illustrating some modules of a system for anonymous identification and interaction between electronic devices which may function as software rules engines according to various embodiments described herein.

FIG. 6 illustrates a block diagram of an example method for anonymous identification and interaction between electronic devices according to various embodiments described herein.

FIG. 7 shows a block diagram of another example of a method for anonymous identification and interaction between electronic devices according to various embodiments described herein.

FIG. 8 depicts a block diagram of a further example of a method for anonymous identification and interaction between electronic devices according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the term “computer” refers to a machine, apparatus, or device that is capable of accepting and performing logic operations from software code. The term “application”, “software”, “software code” or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software.

The term “electronic device” as used herein is a type of computer comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include: personal computers (PCs), workstations, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

The term “client device” or sometimes “electronic device” or just “device” as used herein is a type of computer generally operated by a person or user of the system. In some embodiments, a client device is a smartphone or computer configured to receive and transmit data to a server or other electronic device which may be operated locally or in the cloud. Non-limiting examples of client devices include: personal computers (PCs), workstations, laptops, tablet PCs including the iPad, cell phones including iOS phones made by Apple Inc., Android OS phones, Microsoft OS phones, Blackberry phones, or generally any electronic device capable of running computer software and displaying information to a user. Certain types of client devices which are portable and easily carried by a person from one location to another may sometimes be referred to as a “mobile device” or “portable device”. Some non-limiting examples of mobile devices include: cell phones, smartphones, tablet computers, laptop computers, wearable computers such as Apple Watch, other smartwatches, Fitbit, other wearable fitness trackers, Google Glasses, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include Wifi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New systems and methods for enabling interaction between electronic devices are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

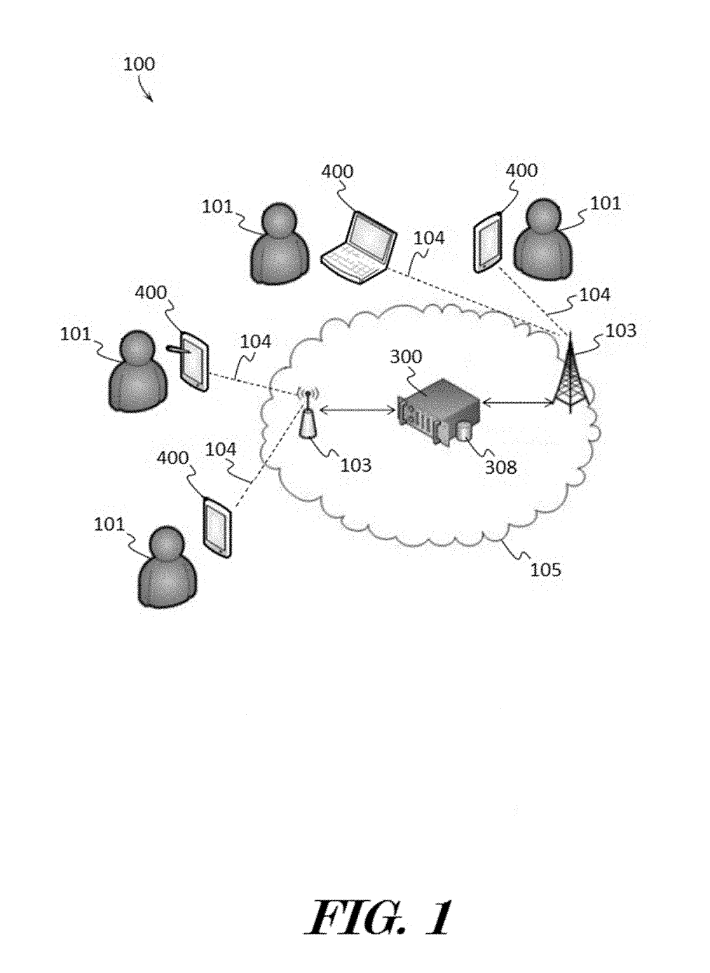

The present invention will now be described by example and through referencing the appended figures representing preferred and alternative embodiments. As perhaps best shown by FIG. 1, an illustrative example of some of the physical components which may comprise a system for anonymous identification and interaction between electronic devices (“the system”) 100 according to some embodiments is presented. The system 100 is configured to facilitate the transfer of data and information between one or more access points 103, client devices 400, and servers 300 over a data network 105. A data store 308 accessible by the server 300 may contain one or more databases. Each client device 400 may send data to and receive data from the data network 105 through a network connection 104 with an access point 103. The data may comprise any information that one or more users 101 desire to input into the system 100 including information describing one or more users 101, information describing the actions of one or more users 101, information requested by one or more users 101, information supplied by one or more users 101, and any other information which a user 101 may desire to input or enter into the system 100.

In this example, the system 100 comprises at least one client device 400 (but preferably more than two client devices 400) configured to be operated by one or more users 101. Client devices 400 can be mobile devices, such as laptops, tablet computers, personal digital assistants, smart phones, and the like, that are equipped with a wireless network interface capable of sending data to one or more servers 300 with access to one or more data stores 308 over a network 105 such as a wireless local area network (WLAN). Additionally, client devices 400 can be fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one client device 400 and/or server 300 programmed to perform one or more of the steps described herein. In preferred embodiments, more than one client device 400 and/or server 300 may be used, with each being programmed to carry out one or more steps of a method or process described herein.

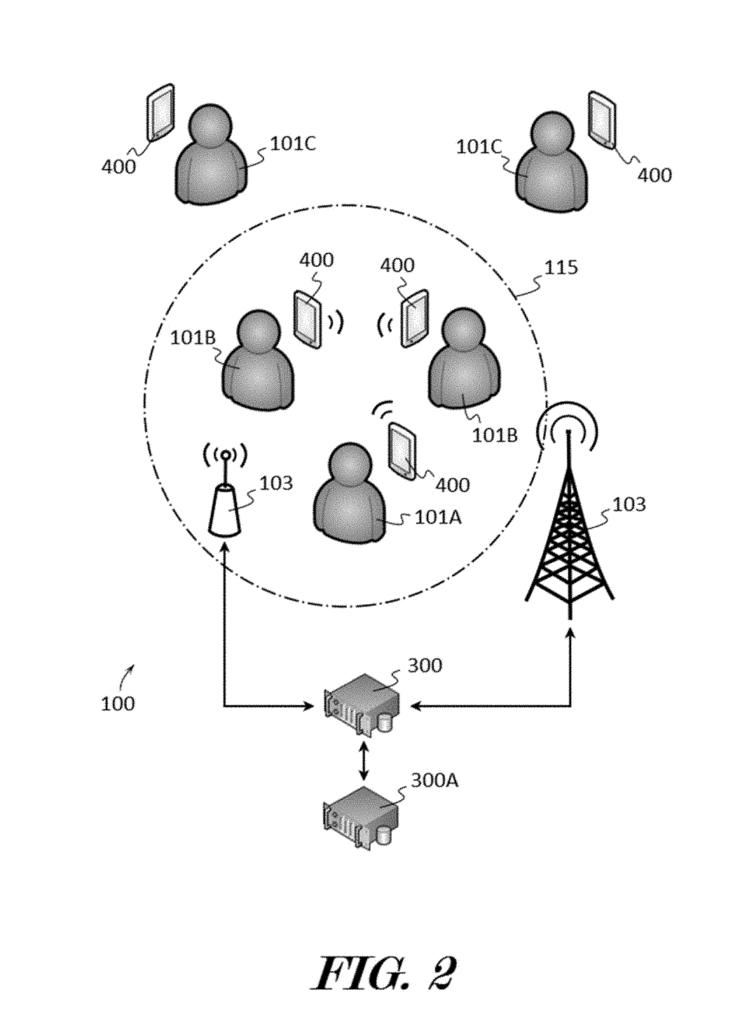

Referring now to FIGS. 1 and 2, the system 100 is configured to allow one or more users 101 to interact with one or more other users 101 over distances without exchange of any account information or user 101 identifying information. Users 101 may include initiating users 101A, participating users 101B, and non-participating users 101C. An initiating user 101A may comprise an individual, having a client device 400, that desires to interact with one or more other users 101 over distances without exchange of any account information or user 101 identifying information. A participating user 101B may comprise an individual, having a client device 400, that is proximate to the initiating user 101A when the initiating user 101A desired to interact with one or more other users 101. A non-participating user 101C may comprise an individual, having a client device 400, that is not proximate to the initiating user 101A when the initiating user 101A desired to interact with one or more other users 101.

The system 100 may enable the client device 400 of a first user 101, such as an initiating user 101A, to anonymously identify and interact with the client device 400 of another user 101, such as a participating user 101B, optionally in real-time and/or optionally at a later time. In some embodiments, the system 100 may identify the presence of one or more second client devices 400 of one or more second users 101 which may be proximate to a first client device 400 of a first user 101 at an event 115 thereby negating the need for a user 101 identifying information to be exchanged between the client devices 400 in order to catalog the presence of a second proximate client device 400 at a specific time or ‘event’. At a future time, the second client device 400 that was present at the event 115 may be registered in the system 100 by a second user 101, and the system 100 may attribute data from the event 115 to the second user 101 associated with the second client device 400 which was present at the event 115. In this manner, the system 100 may enable a first client device 400 to interact with a second client device 400 without requiring user 101 identifying information to be directly exchanged between the first client device 400 and the second client device 400. This enables the transfer of any data relating to one or more prior events involving the participant second client device 400 to be conferred to the account owner second user 101. In some embodiments, this essentially allows users 101 newly registered with the system 100 to claim any pre-existing data related the participation of their client device 400 in past and future events without requiring user 101 identifying information to be directly exchanged between a first client device 400 and a second client device 400. In further embodiments, this essentially allows users 101 currently registered with the system 100 to claim any pre-existing data related the participation of their client device 400 in future events without requiring identifying information to be directly exchanged between a first client device 400 and a second client device 400.

In preferred embodiments, data describing incentives accumulated by a participating user 101B may be provided to a third party account server 300A associated with the participating user 101B. For example, a user 101 may associate a third party account server 300A, such as managed by Facebook, and other social networking sites, Tinder, Eharmony, and other dating sites, LinkedIn, and other career or job networking sites, or any other social media provider, to enable incentives and other system information to be shared with or posted on the Facebook account or other social media account of the user 101. In further preferred embodiments, data describing incentives accumulated by a participating user 101B may be provided to a third party account server 300A associated with the client device 400 of the participating user 101B. For example, a user 101 may associate a third party account server 300A, such as managed by Facebook, or other social media provider with their client device 400 so that when the participating user 101B logs onto Facebook or creates a Facebook account, the incentives associated with the client device 400 of the participating user 101B in the association database 110 may be provided to the Facebook account server 300A. By providing data describing incentives accumulated by a participating user 101B to a third party account server 300A associated with the participating user 101B or associated with the client device 400 of the participating user 101B, other users of the third party account server 300A may be able to judge claims made by the participating user 101B on their social media accounts.

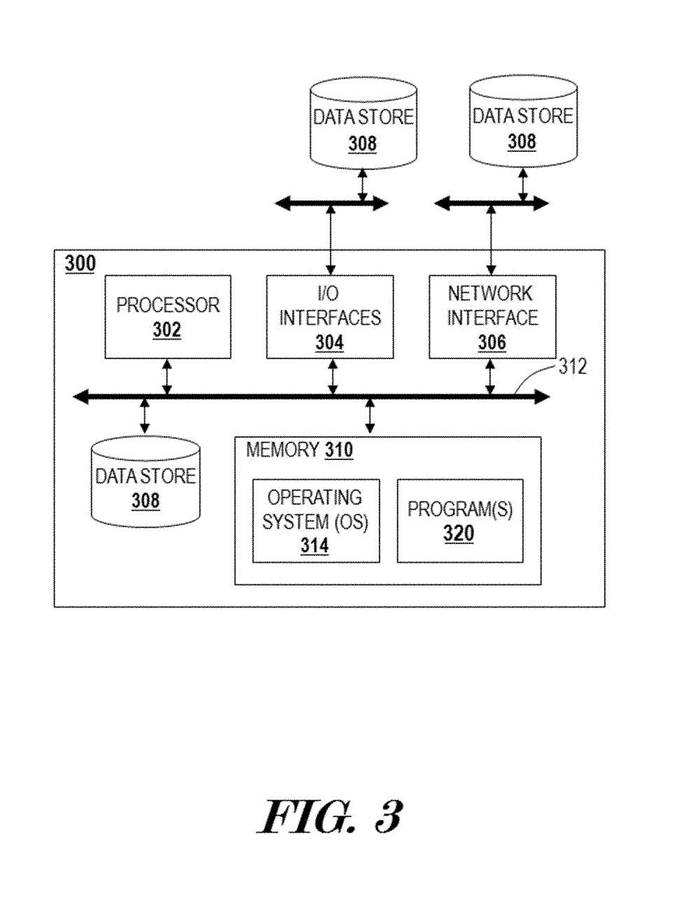

Turning now to FIG. 3, in an exemplary embodiment, a block diagram illustrates a server 300 of which one or more may be used in the system 100 or standalone. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 3 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like. The one or more programs 320 may be configured to implement the various processes, algorithms, methods, techniques, etc. described herein.

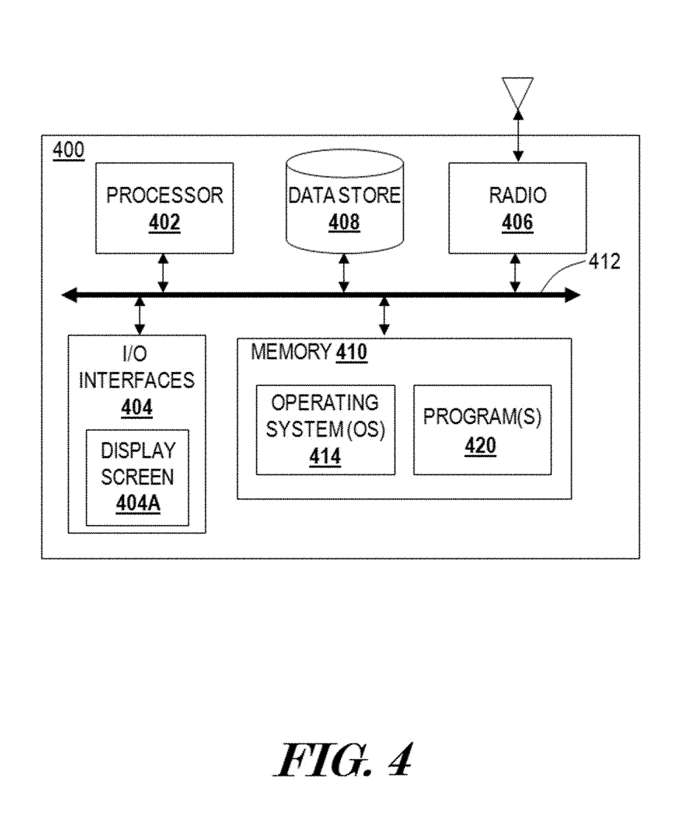

Referring to FIG. 4, in an exemplary embodiment, a block diagram illustrates a client device 400 of which one or more may be used in the system 100 or the like. The client device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 4 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, bar code scanner, voice recognition, eye gesture, and the like. System output can be provided via a display device such as a liquid crystal display (LCD), touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the client device 400. Additionally, the I/O interfaces 404 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 4, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), and the like. The programs 420 may include various applications, add-ons, etc. configured to provide end user functionality with the client device 400. For example, programs 420 may include, but not limited to, a web browser, social networking applications, streaming media applications, games, mapping and location applications, electronic mail applications, financial applications, and the like. In a typical example, the end user typically uses one or more of the programs 420 along with a network such as the system 100.

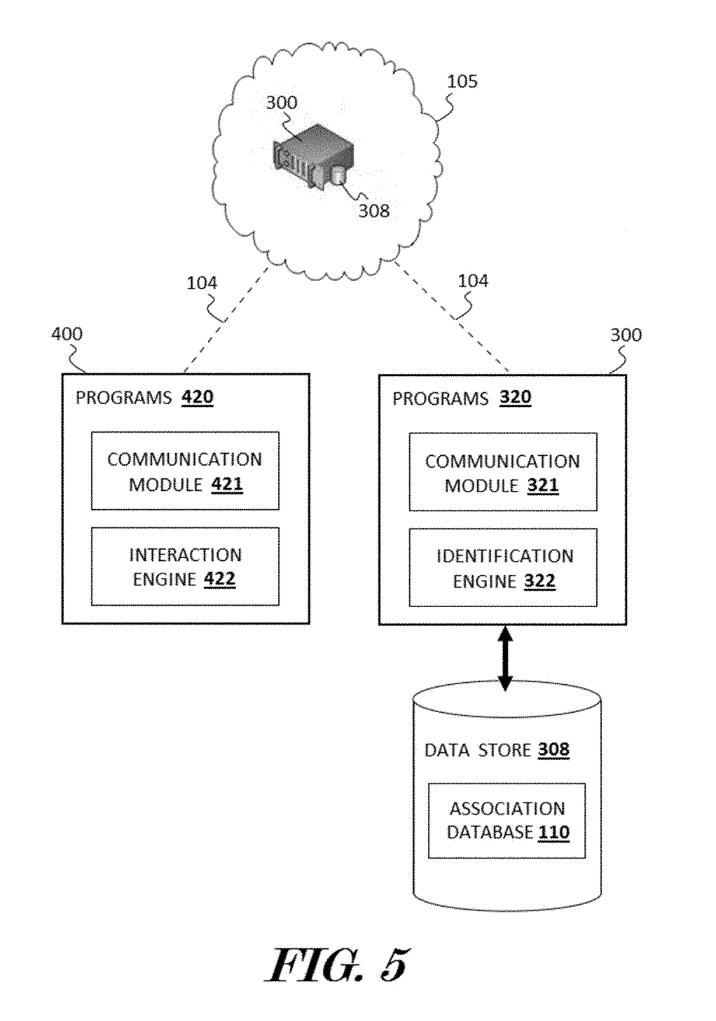

FIG. 5 depicts a block diagram showing some software rules engines which may be found in a system 100 and which may optionally be configured to run on a server 300 and/or a client device 400 according to various embodiments described herein. In some embodiments, one or more servers 300 may be configured to run one or more software rules engines or programs 320 such as a communications module 321 and/or an identification engine 322. In this embodiment, the modules and engines 321, 322, are configured to run on at least one server 300. The server 300 may be in electronic communication with a data store 308 comprising a database, such as an association database 110. The engines 321, 322, may read, write, or otherwise access data in the database 110 of the data store 308. Additionally, data may be sent and received to and from one or more client devices 400 which may be in wired and/or wireless electronic communication with a server 300 on a network 105 through a network connection 104. A client device 400 may be configured to run one or more software rules engines or programs 420 such as a communications module 421 and/or an interaction engine 422. In other embodiments, a communications module 321, identification engine 322, a communications module 421, and/or an interaction engine 422 may be configured to run on a client device 400 and/or server 300 with data transferred to and from one or more servers 300 in communication with an association database 110 of a data store 308 through a network 105.

The system 100 may comprise an association database 110 stored on a data store 308 accessible to the communications module 321 and/or identification engine 322. In some embodiments, the association database 110 may comprise data and information on one or more users 101 such as data describing one or more users 101, data describing one or more client devices 400, data associating a user 101 with one or more client devices 400, and/or data describing one or more events. Data describing one or more users 101 may include the name, age, address, phone number, email, system identification (ID), system password, preferred methods of communication, points earned by the user, awards earned by the user, time spent at a location, time spent in proximity to another user, time spent in proximity to a client device 400, friends of the user, and/or any other data or information which may describe the user 101 and/or the activities of the user 101. Data describing one or more client devices 400 may include the type of device, phone number, email address, system identification (ID), universally unique identifier (UUID), globally unique identifier (GUID), or Unique User Identification (UUID) typically comprising a 128-bit number used to identify information in computer systems, system password, points earned by the client device, awards earned by the client device, time spent at a location, time spent in proximity to another user, time spent in proximity to a client device 400, and/or any other data or information which may describe the client device 400 and/or the activities of the client device 400. Data associating a user 101 with one or more client devices 400 may include data describing which client devices 400 are owned by the user, data describing which client devices 400 are used or manipulated by a user, and/or any other data and information which may be used to link or otherwise associate a user 101 with a client device 400. Data describing one or more events may include data entered by a user 101 or client device 400 of the user 101 at a point in time and identification information of any client device 400 in proximity to the client device 400 of that user 101.

The communication module 321 of a server 300 may be configured to govern electronic communication between the server 300 which is running the communication module 321 and one or more client devices 400, third party databases, and other severs 300. Data from severs 300, data stores 308, and client devices 400 may be received by the communication module 321 which may then electronically communicate the data to the identification engine 322. Likewise, data from the identification engine 322 may be received by the communication module 321 which may then electronically communicate the data to severs 300, data stores 308, and client devices 400. In some embodiments, the communication module 321 may govern the electronic communication by initiating, maintaining, reestablishing, and terminating electronic communication between the server 300 and one or more data stores 308, client devices 400, and other servers 300. In further embodiments, the communication module 322 may control the network interface 306 (FIG. 3) of the server 300 to send and receive data to and from one or more data stores 308, client devices 400, and other servers 300 through a network connection 104 over a network 105.

The communication module 421 of a client device 400 may be similar in function to a communication module 321 of a server 300 and may be configured to govern electronic communication between the client device 400 which is running the communication module 421 and a server 300 of the system 100 and/or one or more other client devices 400. Data from severs 300 and other client devices 400 may be received by the communication module 421 which may then electronically communicate the data to the interaction engine 422. Likewise, data from the interaction engine 422 may be received by the communication module 421 which may then electronically communicate the data to servers 300 and/or other client devices 400. In some embodiments, the communication module 421 may govern the electronic communication by initiating, maintaining, reestablishing, and terminating electronic communication between the client device 400 and a server 300 of the system 100 and/or one or more other client devices 400. In further embodiments, the communication module 421 may control the radio 406 (FIG. 4) or other network interface of the client device 400 to send and receive data to and from one or severs 300 and/or client devices 400 of the system 100 through a network connection 104 over a network 105.

A communication module 421 of a client device 400 and/or a communication module 321 of a server 300 may function as or comprise notification logic stored in a memory 410, 310, and executable by a processor 402, 302. In some embodiments, notification logic may be configured to provide the event data to one or more client devices 400, preferably when a data record is created in the association database 100 in which the data record associates a user 101 with the device identifying information of a client device 400 described in identifying information recorded by detection logic. In further embodiments, notification logic may be configured to provide data describing incentives accumulated by a user 101 to a third party account server 300A associated with the user 101, such as a social media account server, a dating or matchmaking account server, or the like. In still further embodiments, notification logic may be configured to provide data describing incentives accumulated by a user 101 to a third party account server 300A associated with the client device 400 of the user 101. In even further embodiments, notification logic may be configured to provide a notification to the client device 400 of a user 101 when an incentive is accumulated by the user 101 in the association database 110.

Additionally, communication module 421 of a client device 400 and/or a communication module 321 of a server 300 may function as or comprise event creation logic stored in a memory 410, 310, and executable by a processor 402, 302. In some embodiments, event creation logic of a communication module 421 running on a client device 400 may be configured to create an event creation request from input provided by a first user 101, such as an initiating user 101A, via their client device 400 in which the event creation request preferably comprises event data and a request to interact with one or more client devices of one or more second users 101, such as one or more participating users 101B, proximate to the first user 101, 101A. In further embodiments, event creation logic of a communication module 321 running on a server 300 may be configured to receive an event creation request from a first user 101, such as an initiating user 101A, via their client device 400 in which the event creation request preferably comprises event data and a request to interact with one or more client devices of one or more second users 101, such as one or more participating users 101B, proximate to the first user 101, 101A. Event data may comprise information input by an initiating user 101A which may describe a name for the event, a reason or other descriptive information of the event, date, time, and location information of the event. Optionally, event data may comprise an incentive. An incentive may comprise a reward, such as points or other discrete units which may be accumulated or awarded to a user 101 in the association database 110. For example, an incentive may comprise five points which may be associated with the data record of each client device 400 that was proximate to a client device 400 that generated an event creation request. A request to interact may comprise information, such as a proximity distance or other proximity defining information, which may be used by the interaction engine 422 to record identifying information of second client devices 400 proximate to a first client device 400. Additionally, the request to interact may comprise the identifying information of the first client device 400 and the identifying information of second client devices 400 proximate to a first client device 400.

The interaction engine 422, optionally run on a client device 400, may be configured to manipulate data input by the user 101 of the client device 400, to manipulate data received by the communication module 421, and to provide the manipulated data to the communication module 421 for transmission to a server 300, such as to the communication module 321. In some embodiments, the interaction engine 422 may receive input into the client device by the user 101 of the client device 400 that the user desires to input into the system 100. This data may describe actions of the user 101, actions of a second user 101, or any other information that a user 101 may wish to input. In further embodiments, the interaction engine 422 may output data and information from the system 100 through the client device 400 of the user 101 through an input/output (I/O) interface 404 such as a display or touch screen. In further embodiments, the interaction engine 422 may catalogue or create a list of any electronic devices 400 which are in proximity to the client device 400 running the interaction engine 422. Optionally, the communication module 421 may detect wireless communications from proximate client devices 400 and this information may be passed to the interaction engine 422 which may then use this information to create the catalogue or listing. Preferably, the communication module 421 may use data contained in a request to interact may comprise information, which may identify a proximity distance or other proximity defining information, which may be used by the interaction engine 422 to determine which second client devices 400 are proximate to a first client device 400. For example, a request to interact may comprise data defining proximate as within Bluetooth communication range, within WiFi communication range, within a defined wireless communication signal strength range or threshold, all client devices 400 in wireless communication with the same access point 103, all client devices 400 in wireless communication with the two or more access points 103, all client devices 400 in defined geographic area, all client devices 400 in a building or other property, or any other data which may be used to identify the client devices 400 of participating users 101B versus the client devices 400 of non-participating users 101C.

An interaction engine 422 of a client device 400 may function as or comprise detection logic stored in a memory 410, 310, and executable by a processor 402, 302. In some embodiments, detection logic of an interaction engine 422 running on a first client device 400 may be configured to record identifying information from one or more second client devices 400 proximate to the first client device 400. For example, detection logic of an interaction engine 422 running on a first client device 400 of an initiating user 101A may record identifying information from one or more second client devices 400 of one or more participating user 101B that are proximate to the first client device 400. Preferably, identifying information of a second client device 400 may be recorded by the detection logic via wireless communication, such as WiFi, Bluetooth, or other wireless data communication protocol supported by the radios 406 of the client devices 400, between the first client device 400 and the second client device 400.

The identification engine 322, optionally run on a server 300, may be configured to send, receive, access, modify, and otherwise manipulate data in an association database 110 of a data store 308. Once an event creation request is received by the identification engine 322, the identification engine 322 may create an event data record in the association database 110. An event data record may comprise event data information and request to interact information provided by the event creation logic and detection logic of a client device 400 of an initiating user 101A.

In some embodiments, the identification engine 322 may be configured to match an identifier of an client device 400 to electronic devices 400 within the association database 110. If the association database 110 does not contain a matching client device 400, the identification engine 322 may create a data record for the unmatched client device 400 identifier. In further embodiments, the identification engine 322 may associate information and data from the interaction engine 422 with the identifier of a client device 400 and preferably with the user account of a user 101 which is associated with the client device 400 identifier in the association database 110.

An identification engine 322 may function as or comprise recording logic stored in a memory 410, 310, and executable by a processor 402, 302. In some embodiments, recording logic of an identification engine 322 may be configured to store event data and recorded identifying information of one or more second client devices 400 in an association database 110. In further embodiments, recording logic of an identification engine 322 may be configured to record an incentive in the event data record associated with a second client device 400 when the second client device 400 is recorded as being proximate to the client device 400 of the initiating user 101A which provided the event creation request.

An identification engine 322 may function as or comprise matching logic stored in a memory 410, 310, and executable by a processor 402, 302. In some embodiments, matching logic of an identification engine 322 may be configured to determine if the device identifying information of a second client device 400 contained in request to interact information matches a client device 400 associated with a user 101 in the association database 110.

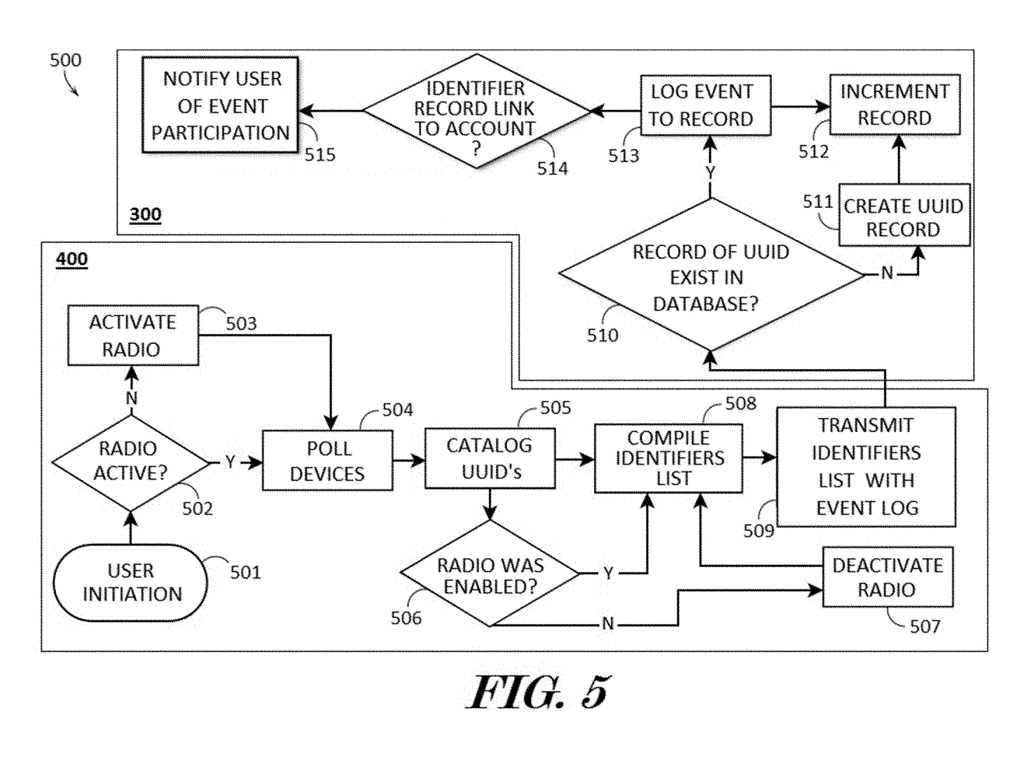

Turning now to FIG. 6 a method for anonymous identification and interaction between electronic devices (“the method”) 500 according to various embodiments is illustrated. The method 500 may enable the system 100 to perform anonymous identification of and interaction between one or more electronic devices 400. One or more steps of the method 500 may be performed by a communications module 321 of a server 300, an identification engine 322 of a server 300, a communications module 421 of a client device 400, and/or an interaction engine 422 of a client device 400.

In some embodiments, the method 500 may start with user initiation in step 501. The interaction engine 422 may receive data that a first user 101 has input into their first client device 400. This data may describe the actions of a user, such as a second user 101 and/or the actions of the first user 101. In some embodiments, the client device 400 of the first user 101 may provide location data to the interaction engine 422.

The communication module 421 may determine in decision block 502 if a radio 406, such as a Bluetooth radio, WiFi radio, and NFC radio, is active. If a radio 406 is not active, the communication module 421 may activate a desired radio 406, such as the Bluetooth radio in step 503, of the first client device 400. The method 500 may then continue to step 504. If the radio 406 is active at decision block 502, the method 500 may also continue to step 504.

In step 504, the communication module 421 may control the radio 406 to poll for one or more second client devices 400 which are in range or proximate to the first client device 400 running the communication module 421. By polling the second client devices 400, the communication module 421 may solicit any second client devices 400 which are proximate to the first client device 400 to broadcast their Unique User Identification (UUID) or universally unique identifier (UUID). A UUID may comprise any identifier standard used in software construction, such as a 128-bit value, in which the meaning of each bit may be defined by any of several variants. For example, a UUID may be the MAC address of a second client device 400 or any other suitable identifier broadcast by a client device 400.

Next in step 505, the system 100 may catalog the unique identifiers of any second client devices 400 which are proximate or in range. In some embodiments, the communications module 421 may record and catalogue or otherwise create a listing of the recorded UUIDs or other suitable identifiers. In alternative embodiments, the communications module 421 may record any broadcast UUIDs or other suitable identifiers and then provide this information to the interaction engine 422 for cataloging. The method 500 may then continue to step 508.

In some embodiments, the method 500 may optionally include decision block 506 in which the communication module 421 may determine if the radio 406, such as a Bluetooth radio, was enabled at the time of the user initiation in step 501. If the radio 406 was not enabled, the method 500 may continue to optional step 507 and the communication module 421 may deactivate the radio 406. After optional step 507 and/or if the radio 406, such as a Bluetooth radio, was enabled at the time of the user initiation in step 501, the method 500 may continue to step 508.

Continuing to step 508, the system 100 may compile a list of device identifiers for communication to the server 300. In some embodiments, the list may be compiled by the interaction engine 422 using information describing the detected UUIDs or other suitable identifiers provided by the communications module 421. In further embodiments, the detected UUIDs or other suitable identifiers may be associated with data input by the user in step 501 by the interaction engine 422.

In step 509, the system 100 may transmit a list of identifiers along with an event log to the server 300 or central computer. In some embodiments, the communication module 421 may send the list of identifiers along with an event log to the communications module 321 of the server 300 and the communications module 321 may provide the data to the identification engine 322 with the identification engine 322 storing the data in the association database 110.

Continuing to decision block 510, the system 100 may determine if a record of each UUID in the list of identifiers along with event log is pre-existing in the association database 110. In some embodiments, the identification engine 322 may compare a UUID in the list with the UUIDs in the association database 110. If the UUID does not match a pre-existing data record in the association database 110, the method 500 may continue to step 511 and the identification engine 322 may create a UUID record for the new UUID optionally by incrementing the UUID record field in the association database 110 in step 512 with the method 500 continuing to step 513. If the UUID does match a pre-existing data record in the association database 110, the method 500 may continue to step 513.

In step 513, the system 100 may log the event to an existing data record in the database. In some embodiments, the identification engine 322 may store any data contained in the event log received from the client device 400 which is relevant to or describing the UUID in the pre-existing data record in the association database 110. In other embodiments, the identification engine 322 may store any data contained in the event log received from the client device 400 which is relevant to or describing the UUID in the newly created data record (from steps 511-512) in the association database 110.

Next in step 514, the system 100 may determine if the UUID record links to or is associated with a user account. Preferably a user 101 may register with the system 100 by providing information describing the user 101, such as contact or other identifying information, and the UUID of one or more client devices 400 that the user 101 owns or uses. This information may be stored in the association database 110. In some embodiments, the identification engine 322 may determine if the UUID record links to or is associated with a user account in the association database 110. If the UUID from the event log matches a user account the owner of the account may be notified of participation in the event preferably by a communication to one or more of the client devices 400 that the user 101 owns or uses and which is stored in the association database 110 in step 515. In further embodiments, steps 501-515 may be repeated for every UUID in the log transmitted by the client device 400 in step 509.

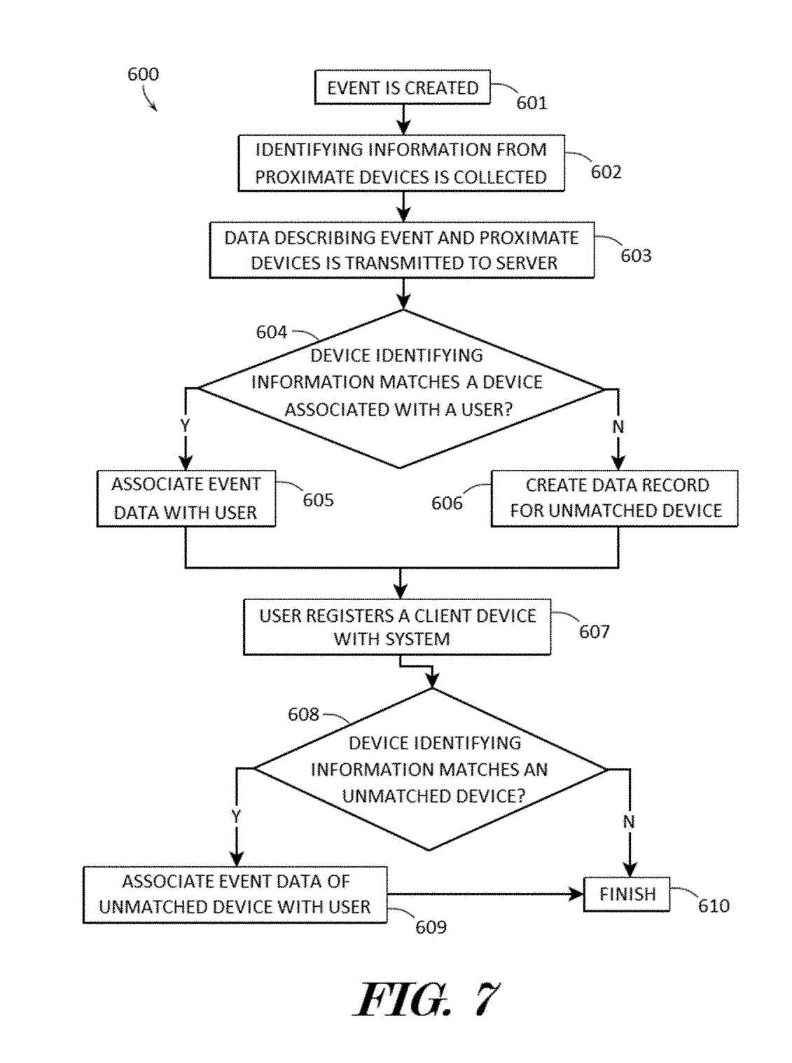

FIG. 7 shows a block diagram of an example of another example of a method for anonymous identification and interaction between electronic devices (“the method”) 600 according to various embodiments described herein. The method 600 may be used by the system 100 to perform anonymous identification and interaction of and between one or more electronic devices 400. For example, the method 600 may be used to record proximity to other people or devices, to provide data to a client device 400 at a later time, allow users to interact with individuals over short distances without exchange of any account information, and the like. One or more steps of the method 600 may be performed by a communications module 321 of a server 300, an identification engine 322 of a server 300, a communications module 421 of a client device 400, and/or an interaction engine 422 of a client device 400.

For the purposes of providing an example to illuminate FIG. 7 and also referring to FIG. 2, an example scenario of a first user 101 witnessing an individual performing an act of kindness will be consistently referred to. In some embodiments, the method 600 may start and an event creation request may be created in step 601. An event 115 may be a point in time or a period in time in which a first user 101 desires to interact with one or more second users 101, by way of their respective client devices 400, over short distances without exchange of any account information. An event creation request may be initiated by a first user 101 such as by input of the first user 101 into their first client device 400. In the example scenario, a first user 101 may witness a second user 101 performing a good deed of giving up their seat on a transit bus for an elderly woman. The first user 101 may create an event creation request by manipulating their smartphone client device 400. Additionally, the first user 101 may input data describing the event 115 into their client device 400 such as by awarding an incentive which may be points to the second user 101 performing the good deed. The interaction engine 422 may then create an event log.

Next in step 602, identifying information from proximate client devices 400 may be collected by the system 100. In some embodiments, the communications module 421 may record the UUIDs of any proximate client devices 400, such as by using Bluetooth, WiFi, or other wireless communication protocols and the communications module 421 may compile a listing of the proximate device 400 UUIDs. In the example scenario, the first client device 400 may record UUID information from any active second client devices 400 which are proximate, such as in wireless range and/or by GPS or other location data, to the first client device 400.

Continuing to step 603, data describing the event and proximate devices 400 may be transmitted to the server 300. In some embodiments, the communications module 421 may communicate the data to a communications module 321 of the sever 300 through a wired or wireless network connection 104. Continuing the example scenario, the communications module 421 of the first client device 400 may transmit the data describing the good deed event, such as awarded points, to the communications module 321 of the sever 300.

In decision block 604, the system 100 may determine if the UUIDs or device identifying information in the transmitted data matches a client device 400 associated with a user 101. In some embodiments, the identification engine 322 may search an association database 110 for each UUID in the transmitted data to determine if the UUIDs or device identifying information in the transmitted data matches a client device 400 associated with a user 101.

If a UUID or device identifying information of a second client device 400 matches a UUID or device identifying information of client device 400 associated with a second user 101, the transmitted data describing the event and the matching client device 400 may be associated with the matching user 101 in step 605. In some embodiments, the identification engine 322 may associate the transmitted data describing the event with the user account information of the second user 101. In the example scenario, if the associating database 101 has an account record with the matching UUID, the identification engine 322 may associate the transmitted data describing the event, such as awarded points, with the user account information of the second user 101.

If a UUID or device identifying information of a second client device 400 does not match a UUID or device identifying information of client device 400 associated with a second user 101 in the association database 110, a new data record comprising the unmatched UUID may be created in the association database 110 and the transmitted data describing the event and the matching client device 400 may be associated with the created data record in step 606. In the example scenario, if the associating database 101 does not have an account record with the matching UUID, the identification engine 322 may associate the transmitted data describing the event, such as awarded points, with the created data record.

In step 607, a user 101 may register a client device 400 with the system 100. In some embodiments, a user 101 may register a client device 400 with the system 100 by creating a user account data record. The user account may contain contact or other identifying information describing the user 101 and the UUID of one or more client devices that the user 101 owns or uses. In further embodiments, a user 101 may register a client device 400 with the system 100 by adding a UUID of their client device 400 to their user account data record. The identification engine 322 may create a user account data record describing the user 101 and their one or more client devices 400 in the association database 110. In the example scenario, a user, such as the second user 101 or any other user 101, may register their client device 400 with the system 100 by providing a UUID of that client device 400.

The method 600 may then continue to decision block 608 and the system 100 may determine if the registered device identifying information or UUID matches a data record comprising a UUID with associated event data that is not matched to a user 101 or user account. In some embodiments, the identification engine 322 may search the association database 110 to determine if the registered device identifying information or UUID matches a data record comprising a UUID with associated event data that is not matched to a user 101 or user account. If the device identifying information does not match, the method may finish 610.

If the device identifying information or UUID does match the UUID of a user account or a client device 440 that is otherwise registered with the system 100, the method may continue to step 609 and the event data of the unmatched client device 400 may be associated with the user 101 having the matching UUID associated with their user account and the method 600 may finish 610. Continuing the example scenario, the second user 101 may register with the system 100 by registering their second client device 400 in the system 100 by providing the UUID of the second client device 400. The identification engine 322 may then search the association database 110 for any data records containing the UUID of the second client device 400. If the UUID matches a data record, the event data associated with the matching data records may be associated with the second user's account. In this manner the points awarded to the second user 101 by the first user 101 may be collected by the second user 101 even though the second user 101 was not enrolled in the system 100 at the time of the event or when the first user 101 desired to award the points.

In further example scenarios and embodiments, the methods 500 and 600 may be used to determine how much time a user 101 spends at a particular establishment. The more time spent proximal to a fixed source, the more loyalty points might be earned. More mobile applications may include games of ‘tag’ where the object is to be close enough to ‘capture’ a target device (fixed or mobile) UUID. For example, the celebrity-chasing niche market may employ this method as an autograph book, capturing and collecting the UUIDs (and thus profiles) of celebrities in a non-invasive way. The business details for something like this fall outside of the scope of the patent, but this should provide some insight into the nature of the breadth of the potential uses.

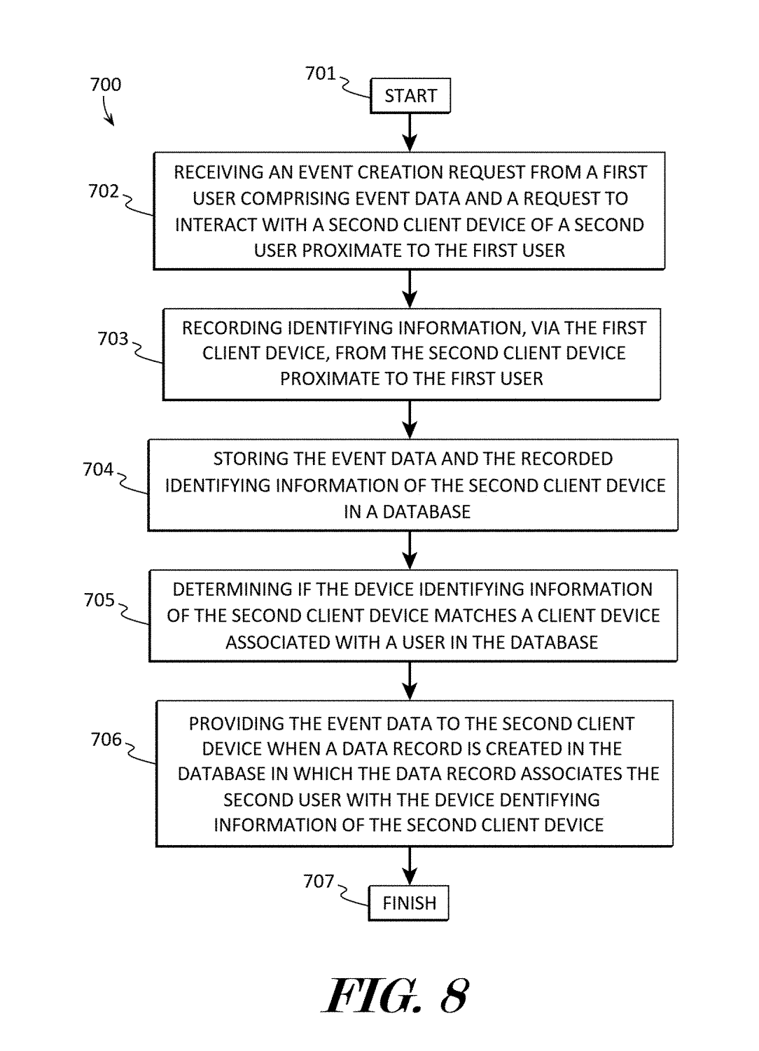

FIG. 8 depicts a block diagram of a further example of a method for anonymous identification and interaction between electronic devices (“the method”) 700 according to various embodiments described herein. The method 700 may be used by the system 100 to perform anonymous identification and interaction of and between one or more electronic devices 400. For example, the method 600 may be used to record proximity to other people or devices, to provide data to a client device 400 at a later time, allow users to interact with individuals over short distances without exchange of any account information, and the like. One or more steps of the method 600 may be performed by a communications module 321 of a server 300, an identification engine 322 of a server 300, a communications module 421 of a client device 400, and/or an interaction engine 422 of a client device 400.

For the purposes of providing an example to illuminate FIG. 8 and also referring to FIG. 2, an example scenario of a first user 101 witnessing an individual performing an act of kindness will be consistently referred to. In the example of FIG. 2, an initiating user 101A and one or more other participating users 101B may be present at an event 115 at which a first user 101 may have witnessed an individual performing an act of kindness or other good deed. An event 115 generally may comprise a time and place at which an initiating user 101A and one or more other participating users 101B may all be present at. For example, an event 115 may comprise an initiating user 101A and one or more other participating users 101B all being in the same elevator car, on the same bus, train, or other public transportation, in the same waiting room, same public park, or other location.

In some embodiments, the method 700 may start an event creation request may be received by the system 100 from a first or initiating user 101A, via their respective client device 400 running a communication module 421, comprising event data and a request to interact with one or more second client devices 400 of a second or participating user 101B that is proximate to the first user 101A at the event 115 in step 702. For example, the event may comprise an initiating user 101A witnessing an individual helping an elderly person across a busy street in the presence of one or more other individuals who may be referred to as participating users 101B. Individuals not proximate to the initiating user 101A may be referred to as non-participating users 101C.

In step 703, identifying information of the second client devices 400 of the participating users 101B proximate to the initiating user 101A may be recorded by the interaction engine 422 running on the first client device 400 of the initiating user 101A. Preferably, identifying information of the second client devices 400 may comprise a universally unique identifier (UUID) of each second client device 400.

Next in step 704, the event data and the recorded identifying information of the second client devices 400 may be recorded in an event data record for the event 115 in the association database 110 by the identification engine 322. In some embodiments, the event data may comprise a description of the event 115 and optionally an incentive selected by the initiating user 101A. In other embodiments, the event data may comprise a description of the event 115 and optionally an incentive selected by the system 100 depending on the description of the event 115.

In step 705, the identification engine 322 may determine if the device identifying information of each second client device 400 in the event data record for the event 115 matches a client device 400 associated with a user 101 in the association database 110. If the device identifying information of a second client device 400 in the event data record for the event 115 matches a client device 400 associated with a user 101, an incentive may be accumulated in the data record of the user 101 and their client device 400. Preferably, a notification may be provided to the client device 400 of the user 101 when an incentive is accumulated by the user 101 in the association database 110. In further embodiments, data describing incentives accumulated by a user 101 may be provided to a third party account server 300A associated with the user 101. In still further embodiments, data describing incentives accumulated by a user 101 may be provided to a third party account server 300A associated with the client device 400 of the user 101.

In step 706, event data may be provided to a second client device 400 when a data record is created in the association database 110 in which the data record associates a second or participating user 101B with the device identifying information of the second client device 400 contained in the event data record. Preferably, a notification may be provided to the client device 400 of the user 101 when an incentive is accumulated by the user 101 in the association database 110. In further embodiments, data describing incentives accumulated by a user 101 may be provided to a third party account server 300A associated with the user 101. In still further embodiments, data describing incentives accumulated by a user 101 may be provided to a third party account server 300A associated with the client device 400 of the user 101. After step 706, the method 700 may finish 707.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD) or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or WiFi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device such as a personal digital assistant (PDA), laptop computer, or cellular telephone. The LAN communications network and the other communications networks such as cellular wireless and wifi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A method for anonymous identification and interaction between electronic devices, the method comprising the steps of:
receiving an event creation request from a first user, via a first client device, the event creation request comprising event data and a request to interact with a second client device of a second user proximate to the first user;
recording identifying information, via the first client device, from the second client device proximate to the first user;
storing the event data and the recorded identifying information of the second client device in a database, the database accessible to a server;
determining if the device identifying information of the second client device matches a client device associated with a user in the database; and
providing the event data to the second client device when a data record is created in the database, the data record associating the second user with the device identifying information of the second client device.

2. The method of claim 1, wherein the event data comprises an incentive.

3. The method of claim 1, wherein an incentive is accumulated in the data record associated with the second client device when the second client device is recorded as being proximate to a client device which provided an event creation request.

4. The method of claim 3, wherein data describing incentives accumulated by a user is provided to a third party account server associated with the user.

5. The method of claim 3, wherein data describing incentives accumulated by a user is provided to a third party account server associated with the client device of the user.

6. The method of claim 3, wherein a notification is provided to the client device of the user when an incentive is accumulated by the user in the database.

7. The method of claim 1, wherein the identifying information of the second client device is recorded via wireless communication between the first client device and the second client device.

8. The method of claim 7, wherein the identifying information of the second client device is recorded via Bluetooth wireless communication between the first client device and the second client device.

9. The method of claim 1, wherein client devices in communication with the same access point are proximate to each other.

10. The method of claim 1, wherein identifying information of the second client device comprises a universally unique identifier.

11. A computer implemented system for anonymous identification and interaction between electronic devices, the system comprising:
a first client device having a display screen and an input interface for receiving input from a first user;
a second client device having a display screen and an input interface for receiving input from a second user;
a computing platform having a processor, a memory in communication with the processor, and
event creation logic stored in the memory, executable by the processor and configured to receive an event creation request from a first user, via the first client device, the event creation request comprising event data and a request to interact with the second client device of a second user proximate to the first user;
detection logic stored in the memory, executable by the processor and configured to record identifying information, via the first client device, from the second client device proximate to the first user;
recording logic stored in the memory, executable by the processor and configured to store the event data and the recorded identifying information of the second client device in a database, the database accessible to a server;
matching logic stored in the memory, executable by the processor and configured to determine if the device identifying information of the second client device matches a client device associated with a user in the database; and
notification logic stored in the memory, executable by the processor and configured to provide the event data to the second client device when a data record is created in the database, the data record associating the second user with the device identifying information of the second client device.

12. The system of claim 11, wherein the event data comprises an incentive.

13. The system of claim 11, wherein the recording logic records an incentive in the data record associated with the second client device when the second client device is recorded as being proximate to a client device which provided an event creation request.

14. The system of claim 13, wherein the notification logic is configured to provide data describing incentives accumulated by a user to a third party account server associated with the user.

15. The system of claim 13, wherein the notification logic is configured to provide data describing incentives accumulated by a user to a third party account server associated with the client device of the user.

16. The system of claim 13, wherein the notification logic is configured to provide a notification to the client device of the user when an incentive is accumulated by the user in the database.

17. The system of claim 11, wherein the identifying information of the second client device is recorded by the detection logic via wireless communication between the first client device and the second client device.

18. The system of claim 17, wherein the identifying information of the second client device is recorded by the detection logic via Bluetooth wireless communication between the first client device and the second client device.

19. The system of claim 11, wherein client devices in communication with the same access point are proximate to each other.

20. The system of claim 11, wherein identifying information of the second client device comprises a universally unique identifier.
